(19) United States
(12) Patent Application Publication
(10) Pub. No.: US 2004/0085570 A1
(43) Pub. Date: May 6, 2004

(54) Visual recognition GUI for localized language selections

(76) Inventors: Jimmy Sfaelos, Eagle, ID (US); Samuel M. Lester, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/284,729

(22) Filed: Oct. 31, 2002

(51) Int. Cl. G06F 15/00

(52) U.S. Cl. 358/1.15

(57) ABSTRACT

A printing device provides menu pages that include visually recognizable images that are selectable to establish a localized language setting for the device. A computer may also display a visually recognizable image that is selectable to establish a localized language setting for the device through printer driver software. Advantages of the disclosed devices and methods include improved navigability of language-related menus that permit the establishment of localized language settings based on well-known and easily recognizable images such as images of geographic locations and images of flags that represent such locations.

### TECHNICAL FIELD

The present disclosure generally relates to printing, and more particularly, to an improved GUI (graphical user interface) that permits the selection of user localized language preferences based on visually recognizable menu items.

### BACKGROUND

Businesses that maintain international offices throughout various parts of the world often staff such offices with employees who communicate in a variety of different languages. As a result, such offices derive significant benefit from computer systems and related peripheral devices, such as printing devices, that are able to accommodate the variety of different languages.

A common problem in such multi-lingual office environments is the frequent need to change language settings on printing devices in order to accommodate the variety of different languages being used. Current text-based menus available on conventional printing devices (discussed below) can make changing language settings quite burdensome, whether they are made on a frequent or infrequent basis. The difficulty in changing printer language settings on an infrequent basis in an office setting that is not multi-lingual is often increased based on a general lack of familiarity with the process for making such changes on various printing devices.

In general, localized language settings on a printing device determine how various status and control information will be presented to a user through a user interface. Status and control information can inform a user about a printer's paper status, toner status, calibration status, ready status, and the like. A user may also have the ability to alter various settings such as the printer's default paper setting or the printer's language setting. Many conventional printing devices are able to provide such status and control information through different interfaces, including, for example, a front menu panel, an embedded web server (EWS) serving web pages to a client computer, and printer driver software executing on a client computer.

As an example, a French-speaking employee who works in a multi-lingual office environment who wants to print a print job (e.g., a document generated within a word processing application), may need to adjust certain printer settings so that various print features will be applied to the print job. The user might physically access a printer's front menu panel to determine and alter the printer's status settings. In addition, the user may also be able to “surf” to the printer from a desktop computer, for example, by entering the printer's URL (uniform resource locator) address into a web browser. The user would then have access to the printer's status settings through a menu page served up from the printer's EWS.

Regardless of the type of user interface involved, the user may need to adjust various printer status settings. However, the localized language setting on the printer may be set in a language other than French (e.g., German) because of a previous user having a different localized language preference. Therefore, the French-speaking user may not be able to read the user interface well enough to make the desired adjustments to the printer settings. In addition, and perhaps more importantly, it is likely that such a user would be unable to follow menu choices presented on the user interface well enough to change the localized language setting on the printer.

Methods currently available for adjusting localized language settings on conventional printing devices have disadvantages. These disadvantages can make it difficult and sometimes impossible for the average user to change the localized language setting on a printing device. The main disadvantage is that current printing devices provide text-based menus when presenting status and control information through a user interface. Thus, menu items related to changing a printer's localized language setting are also text-based. Consequently, if a printing device is set in a localized language a user does not understand, then the user typically cannot read the text-based menu items well enough to navigate through the menu and change the language setting. For example, in the case where a French-speaking user needs to change a localized language setting on a printing device that is already set in German, it is likely that the user does not read German well enough to enable navigation of the menu. Therefore, the user may not be able to change the localized language setting. In such circumstances, users are often relegated to locating a user's manual or finding a more experienced user to help them determine how to make the appropriate change to the localized language setting.

Accordingly, the need exists for an easier way to adjust localized language settings on printing devices that overcomes the disadvantages associated with current methods and devices.

### SUMMARY

In a particular embodiment, a printer displays a menu page including a selectable language localization image. If the language localization image is selected, the printer displays selectable images of various world regions on a menu page. In response to a selected world region, the printer displays images of selectable sub-regions on a menu page. In response to a selected sub-region, the printer is set to function in a localized language corresponding to the selected sub-region.

In another embodiment, a printer displays a menu page including a selectable language localization image. If the language localization image is selected, the printer displays selectable localized language names representing various localized languages. Each localized language name is presented using text from the localized language that is named. If a localized language name is selected, the printer is set to function in the localized language that corresponds with the selected localized language name.

### BRIEF DESCRIPTION OF THE DRAWINGS

The same reference numbers are used throughout the drawings to reference like components and features.

FIG. 1 illustrates a system environment that is suitable for implementing a graphical user interface having visually recognizable images for selecting localized languages on a printing device.

FIG. 2 is a block diagram illustrating in greater detail, a particular embodiment of an input device and a printing device as might be implemented in the system environment of FIG. 1.

FIG. 3 is an example of a menu page having a selectable language localization image as it might appear on a touch sensitive front panel screen of a printing device.

FIG. 4 is an example of a menu page having selectable images representing different regions of the world.

FIG. 5 is an example of a menu page having selectable images representing different sub-regions of the world.

FIG. 6 is an example of a menu page having selectable images representing additional sub-regions of the world.

FIG. 7 is an example of a menu page having selectable text-based localized language names in text that corresponds to the localized languages represented.

FIG. 8 is an example of a menu page having a selectable language localization image as it might appear on a key-based front panel screen of a printing device.

FIG. 9 is an example of a menu page having a selectable language localization image as it might appear on the computer screen of a client computer accessing an embedded web server of a printing device.

FIG. 10 is a flow diagram illustrating an example method for establishing a localized language setting on a printing device such as that illustrated in FIGS. 1 and 2.

FIG. 11 is a flow diagram illustrating an additional example method for establishing a localized language setting on a printing device such as that illustrated in FIGS. 1 and 2.

FIG. 12 is a flow diagram illustrating an additional example method for establishing a localized language setting on a printing device such as that illustrated in FIGS. 1 and 2.

### DETAILED DESCRIPTION

A printing device provides menu pages that include visually recognizable images that are selectable to establish a localized language setting for the device. A computer may also display a visually recognizable image that is selectable to establish a localized language setting for the device through printer driver software. Advantages of the disclosed devices and methods include improved navigability of language-related menus that permit the establishment of localized language settings based on well-known and easily recognizable images such as images of geographic locations and images of flags that represent such locations.

Exemplary System Environment for Implementing a Graphical User Interface Having Visually Recognizable Images for Selecting Localized Languages on a Printing Device

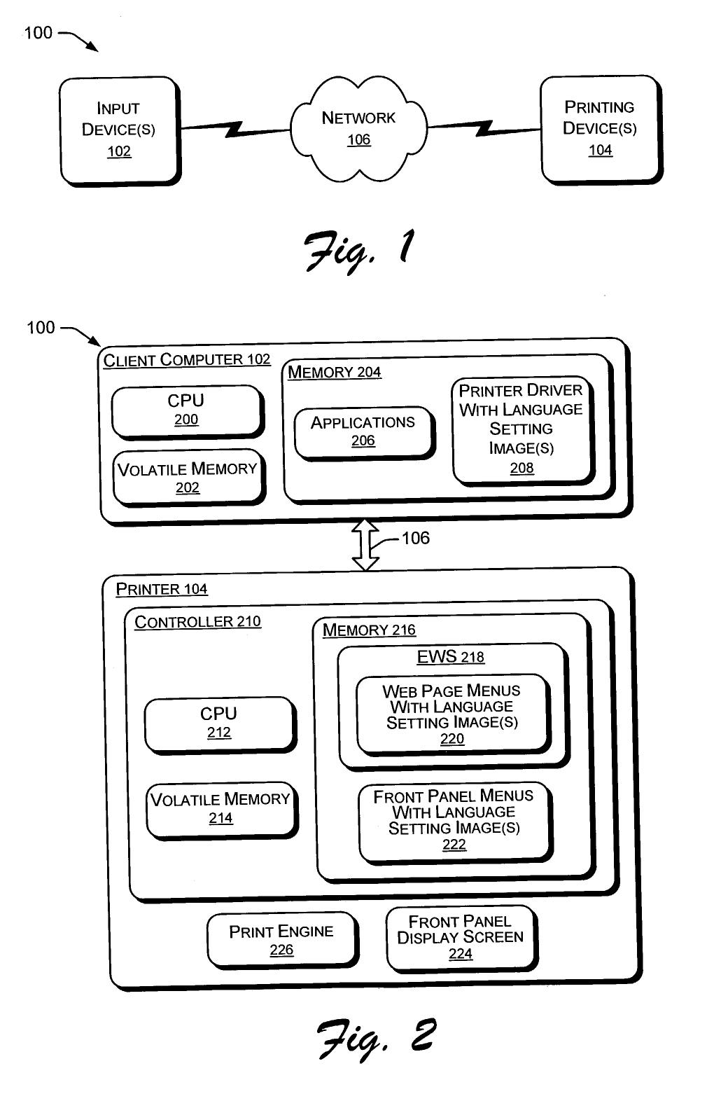

FIG. 1 illustrates an example system environment 100 that is suitable for implementing a graphical user interface that includes visually recognizable images that are selectable by a user for establishing the localized language on a printing device. The exemplary system environment 100 of FIG. 1 includes input device(s) 102 and printing device(s) 104 operatively coupled through a network connection 106. The network connection 106 can include both local and remote connections depending on the particular system configuration. Thus, network connection 106 may include, for example, a printer cable, a LAN (local area network), a WAN (wide area network), an intranet, the Internet, or any other suitable communication link. Network connection 106 might also include a wireless communications link such as an IR (infrared) or RF (radio frequency) link.

Input device(s) 102 can be implemented as a variety of general purpose computing devices including, for example, a personal computer (PC), a laptop computer, a handheld PDA (e.g., Palmtop, PalmPilot), a Macintosh, a workstation computer, and other devices configured to communicate with printing device(s) 104. An input device 102 typically provides a user with the ability to manipulate or otherwise prepare in electronic form, an image or document (e.g., a document generated within a word processing application) that can be rendered as an image to be printed or otherwise formed in hardcopy on a print medium by a printing device 104 after transmission over network 106.

In general, an input device 102 outputs formatted print data to a printing device 104 which converts the data and outputs it onto an appropriate recording media, such as paper or transparencies. Print data from input device 102 is generally formatted by a printer driver into a PDL (page description language) format suitable for printing device 104, such as PCL (Printer Control Language) or PostScript, prior to being sent to printing device 104.

Printing device(s) 104 can be implemented as various types of printers capable of rendering PDL data in printed form on a print medium, such as printing pixels on paper. Therefore, printing device(s) 104 can include devices such as laser-based printers, ink-based printers, dot matrix printers, dry medium printers, plotters and the like. In addition, printing device(s) 104 might also include various multi-function peripheral (MFP) devices that combine a printing function with other functions such as facsimile transmission, scanning, copying and the like.

Exemplary System Embodiments for Implementing a Graphical User Interface Having Visually Recognizable Images for Selecting Localized Languages on a Printing Device

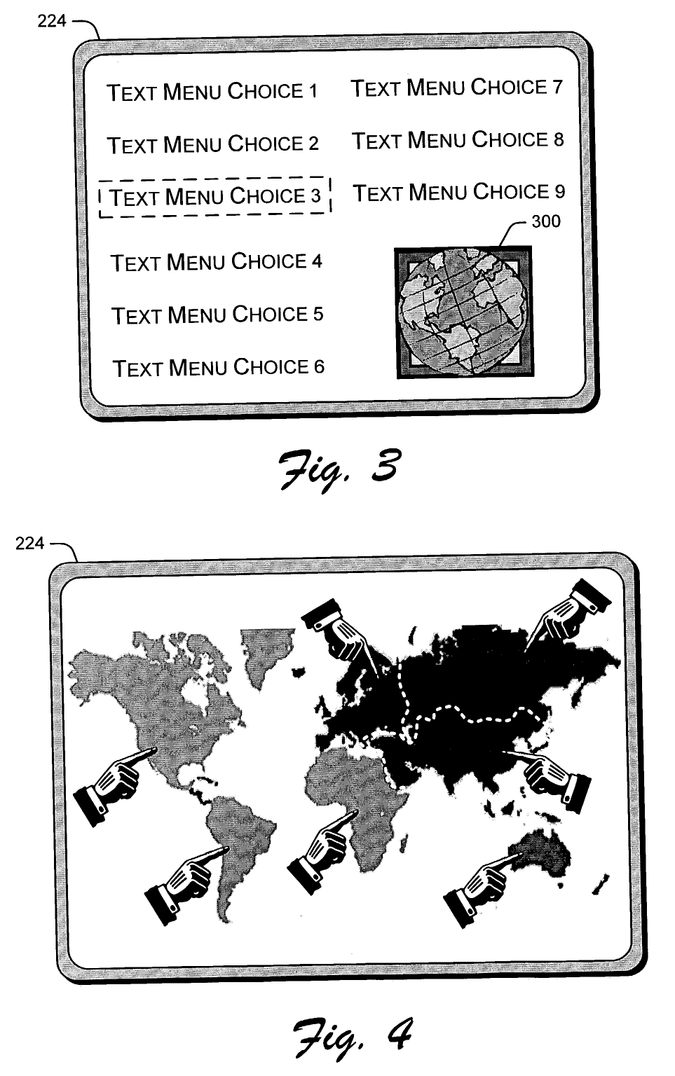

FIG. 2 is a block diagram illustrating an exemplary embodiment of an input device 102 and a printing device 104 as might be implemented in the system environment 100 of FIG. 1. Input device 102 is embodied as client computer 102. Printing device 104 is embodied as printer 104.

Computer 102 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for computer 102. Computer 102 may implement various application programs 206 stored in memory 204 and executable on processor 200 to create or otherwise form a document (e.g., a document generated within a word processing application) or image (e.g., a photograph or graphics) on a computer screen that is transferable over network connection 106 to printer 104 for creating a hard copy of the document/image. Such applications 206 might include software programs implementing, for example, word processors, spread sheets, browsers, multimedia players, illustrators, computer-aided design tools and the like.

Computer 102 also typically implements one or more software-based device drivers such as printer driver 208 that are stored in nonvolatile memory 204 and executable on processor 200. Device drivers might also be implemented on the specific devices they are “driving”, such as printer 104. In general, printer driver 208 receives print data from an application program 206 in an application format and translates it into a printer-friendly format (i.e., a PDL) such as PostScript, PCL, or another appropriate format. The PDL formatted print data is then output to printer 104 where it is rendered and output in hardcopy form onto a print medium such as paper or transparencies. The printer driver 208 illustrated in FIG. 2 may also include one or more images useful for selecting a localized language on a printing device 104 as discussed more fully below.

Printer 104 includes controller 210 that, in general, processes data from computer 102 to control the output of printer 104 through print engine 226. Controller 210 includes a processing unit or CPU 212, a volatile memory 214 (i.e., RAM), and a nonvolatile memory 216. Nonvolatile memory 216 can include various computer storage media such as ROM, flash memory, a hard disk, a removable floppy disk, a removable optical disk and the like. Nonvolatile memory 216 generally provides storage of computer/processor-readable instructions, data structures, program modules and other data for printer 104. Accordingly, nonvolatile memory 216 includes an embedded web server (EWS) 218 and front panel menus 222 configured for display on front panel display screen 224 as discussed more fully below. EWS 218 has associated web page menus 220 with images useful for selecting a localized language on a printing device 104 also discussed more fully below.

In a particular instance of the FIG. 2 embodiment, the front panel menus 222 with localized language setting images are accessed by a user through front panel display screen 224. An example of an initial menu page from front panel menus 222 is illustrated in FIG. 3. FIG. 3 shows an example of front panel display screen 224 implemented as a touch sensitive screen 224 displaying an initial menu page from front panel menus 222. A touch sensitive screen 224 generally enables a user to make menu selections from the screen by touching a menu item displayed on the screen. Thus, the initial menu page displayed on touch sensitive screen 224 of FIG. 3 allows a user to select one of a number of different menu choices. A selected menu choice may be emphasized by a highlight or other selection indicator such as illustrated by the dashed line surrounding “Text Menu Choice 3” of FIG. 3.

The initial menu page illustrated on the touch sensitive display screen 224 of FIG. 3 is intended to show various text-based menu choices (i.e., Text Menu Choices 1-9) that are selectable by a user, in addition to showing a selectable graphical image 300 representing a localized language selection choice. The graphical language localization image 300 might be any image designed to cause a user to understand that selection of the image 300 will allow the user to adjust or establish the localized language setting for the printer 104. Therefore, unlike with the text-based menu choices (i.e., Text Menu Choices 1-9), a user does not need to know how to read the localized language in which the printer 104 is currently set in order to adjust the localized language to a language that the user understands. More specifically, if a user encounters an initial menu page on the front panel display screen 224 that presents menu choices in a localized language the user does not understand, the user should, nevertheless, always be able to change the localized language setting of the printer 104 to a language the user understands through the selection of the graphical language selection image 300.

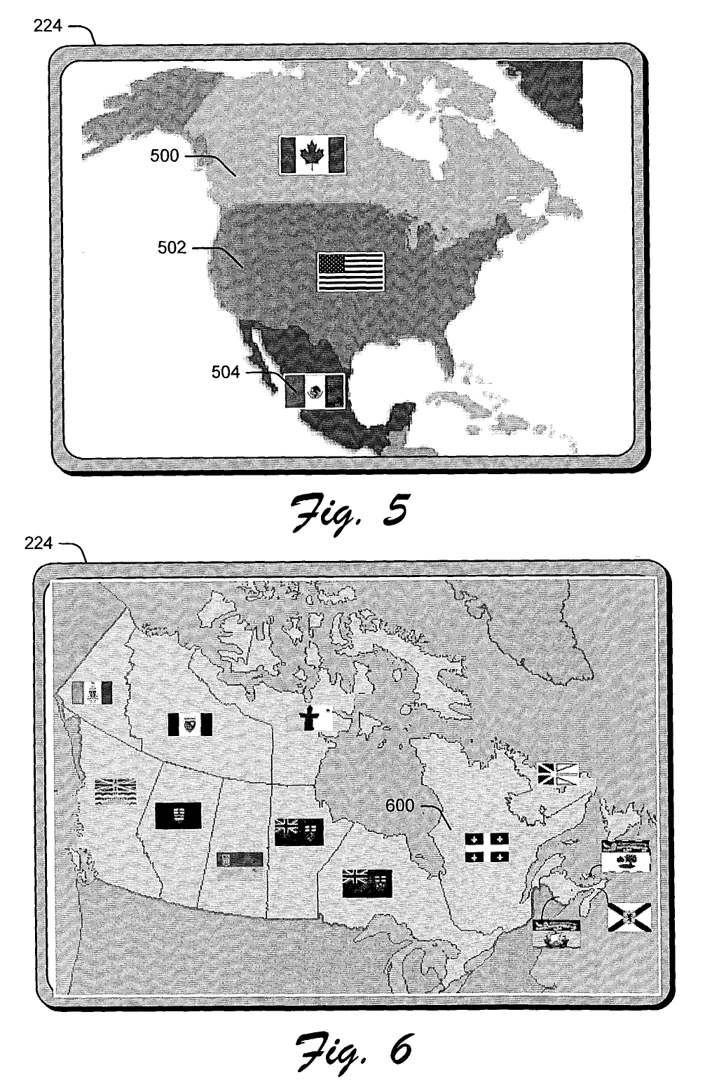

FIG. 4 is an example of a second menu page that might be presented on the touch sensitive front panel display screen 224 in response to a user's selection of the graphical language localization image 300 of FIG. 3. The second menu page includes selectable images that represent various regions of the world. The user may be prompted in some manner, such as by the pointing fingers of FIG. 4, to select a region of the world where the user's desired language is spoken. It is understood that the second menu page presented in FIG. 4 is only an example menu page that includes well-known visually recognizable images likely to be useful in assisting a user to make an appropriate choice toward establishing a desired localized language setting for a printer 104. Therefore, other well-known images might also reasonably be used to assist a user in making such a localized language choice, such as, for example, images of flags that represent various regions of the world.

FIG. 5 is an example of a third menu page that might be presented on the touch sensitive front panel display screen 224 in response to a user's selection of a world region presented on the previous menu page of FIG. 4. The third menu page includes selectable images that represent various sub-regions of one of the world regions presented on the previous menu page of FIG. 4. By selecting a world region shown in FIG. 4, a user essentially increases the focus for a desired localized language setting into the selected world region, as illustrated by the sub-regions of FIG. 5.

Thus, FIG. 5 indicates that a user selected the North American continent from FIG. 4. FIG. 5 illustrates three countries in the North American continent (i.e., Canada 500, the United States 502, and Mexico 504) as examples of sub-regions. The countries may be delineated by colors, lines outlining their borders, flags shown within their borders, combinations of these, and the like. In any event, the sub-regions are distinguishable by well-known images that further assist a user in making an appropriate choice toward establishing a desired localized language setting for a printer 104. For example, a user who wants to set the printer 104 to Spanish, would, at this point, select the country of Mexico 504 as illustrated both by its boundaries and by its flag in FIG. 5.

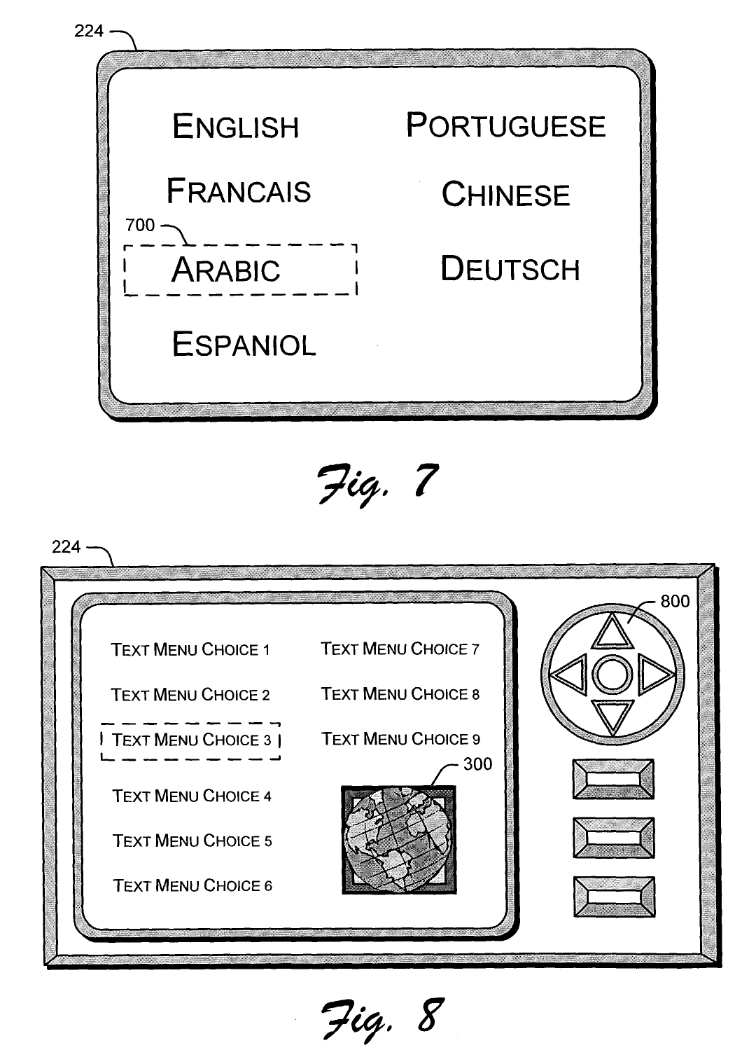

However, further delineation of sub-regions may be necessary in order to narrow down the available localized language choices as illustrated by FIG. 6. For example, a user may be from the French-speaking province of Quebec, Canada. FIG. 6 illustrates a fourth menu page that might be presented on the touch sensitive front panel display screen 224 in response to a user's selection of the sub-region of Canada 500 from FIG. 5. FIG. 6 further sub-divides the sub-regions from FIG. 5. Thus, FIG. 6 illustrates the provinces and territories of Canada 500 by their boundaries and their representative flags. The French-speaking user from Quebec is now able to select Quebec 600 on the touch sensitive front panel display screen 224 in order to set the localized language of the printer 104 to French.

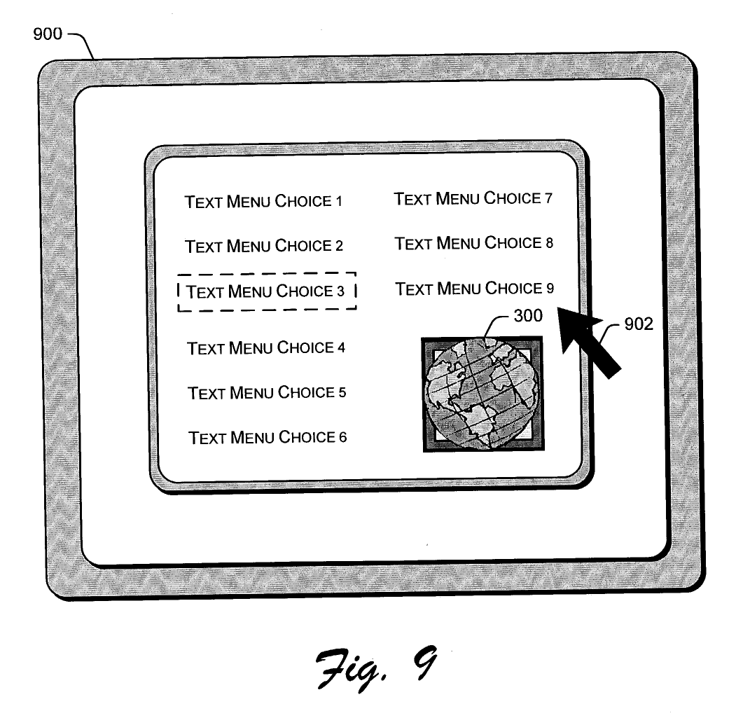

FIG. 7 represents an alternative example of a second menu page that might be presented on the touch sensitive front panel display screen 224 in response to a user's selection of the graphical language localization image 300 of FIG. 3. FIG. 7 is an example of a menu page having selectable text-based localized language names in text that corresponds to the localized languages represented. Thus, FIG. 7 provides a quick alternative method for selecting a desired localized language once a user selects the language localization image 300 of FIG. 3. The idea behind the menu page of FIG. 7 is that once a user understands how to begin a search for a desired localized language (i.e., from the graphical language localization image 300 of FIG. 3), he or she will be able to locate the appropriate localized language written in its corresponding text. For example, an Arabic-speaking user may access the initial menu page through the display screen 224 of FIG. 3 and discover that he does not understand the localized language of the text menu choices. However, he should understand graphical language localization image 300 as a means for adjusting the localized language setting for the printer 104. Once the user selects the graphical language localization image 300, a second menu page such as that illustrated in FIG. 7 listing the Arabic language 700 in Arabic text characters leads the user to a selection of his desired localized language.

FIG. 8 illustrates another instance of the FIG. 2 embodiment where front panel menus 222 having localized language setting images are accessed by a user through front panel display screen 224. However, the front panel display screen 224 of FIG. 8 is implemented as a key based screen rather than a touch sensitive screen. A key based display panel screen 224 generally enables a user to make menu selections from the screen by pushing various keys 800 on the side of the display screen. Thus, the initial menu page displayed on the key based screen 224 of FIG. 8 allows a user to select one of a number of different menu choices. As in the case of the touch sensitive screen of FIG. 3, a selected menu choice may be emphasized by a highlight or other selection indicator such as illustrated by the dashed line surrounding “Text Menu Choice 3” of FIG. 8. The above discussion generally relating to navigating menu pages with reference to FIGS. 3-7 for the purpose selecting a localized language setting for printer 104 applies in a similar manner to the key based display panel screen 224 of FIG. 8.

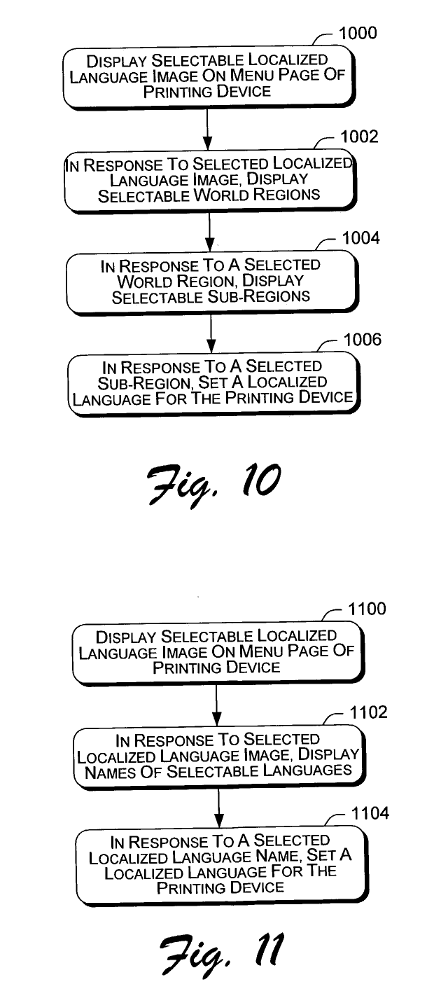

Likewise, the above discussion generally relating to navigating menu pages with reference to FIGS. 3-7 for the purpose selecting a localized language setting for printer 104 also applies to FIG. 9. FIG. 9 illustrates another instance of the FIG. 2 embodiment where web page menus 220 having localized language setting images are accessed by a user via embedded web server (EWS) 218 on printer 104. A user operating a client computer 102 executing a browser application 206 may enter the URL (uniform resource locator) address of printer 104 into the browser. Web page menus 220 that closely parallel the previously discussed front panel menus 222 are then served up to client computer 102 by EWS 218. The web page menus 220 appear on the computer screen 900 of client computer 102 in much the same way as the previously discussed front panel menus 222 appear on the front panel display screen 224 of printer 104. Thus, the process of navigating the web page menus 220 is the same as that described above with respect to FIGS. 3-7, except that selections are made by a user from the client computer 102 through an input device such as a mouse, for example. Cursor 902 of FIG. 9 is intended to illustrate a typical cursor controlled by a user operating a mouse input device. In a typical selection of a menu item, such as “Text Menu Choice 3”, for example, a user operates a mouse to move the cursor over the menu item and then “clicks” on the item with the mouse.

In yet another instance of the FIG. 2 embodiment, a user has access to a graphical language setting image via printer driver 208 executing on client computer 102. In this instance, a print command is initiated, for example, from within an application program 206. Printer driver 208 executes to provide a user with various print options. One such option is a printer settings option that includes a graphical localized language setting image similar to image 300 discussed above regarding FIG. 3. Selection of the graphical localized language setting image results in the presentation of selectable text-based localized language names such as those discussed above regarding FIG. 7. A user can then select the appropriate localized language setting as a default for the client computer 102.

Exemplary Methods for Selecting Localized Languages on a Printing Device

Example methods for selecting or adjusting localized language settings on a printing device will now be described with primary reference to the flow diagrams of FIGS. 10 through 12. The methods apply generally to the exemplary embodiments discussed above with respect to FIGS. 1 through 9. The elements of the described methods may be performed by any appropriate means, such as by the execution of processor-readable instructions defined on processor-readable media, such as a disk, a ROM or other such memory device.

Referring to the method illustrated in FIG. 10, at block 1000, a selectable localized language setting image is displayed on a menu page of printing device. The menu page may be presented on a touch sensitive front panel display screen of the printing device, a key based front panel display screen of the printing device, or a computer screen of a client computer running a browser. At block 1002, images of selectable world regions are displayed in response to a selection of the localized language setting image of block 1000. At block 1004, images of selectable sub-regions are displayed in response to the selection of a world region. At block 1006, a localized language is set on a printing device in response to the selection of a sub-region.

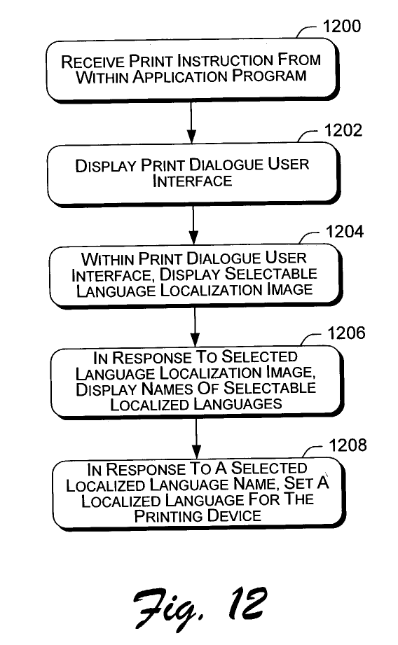

Referring now to the method illustrated in FIG. 11, at block 1100, a selectable localized language setting image is displayed on a menu page of printing device. As in the prior method of FIG. 10, the menu page may be presented on a touch sensitive front panel display screen of the printing device, a key based front panel display screen of the printing device, or a computer screen of a client computer running a browser. At block 1102, names of selectable localized languages are displayed in response to a selection of the localized language setting image of block 1100. The selectable localized language names are displayed using text that corresponds to the localized language that each name represents. At block 1104, a localized language is set on a printing device in response to the selection of a localized language name.

Referring now to the method illustrated in FIG. 12, at block 1200, a print instruction is received from within an application program executing on a client computer. At block 1202, a print dialogue user interface is displayed. The print dialogue user interface is generated by a printer driver executing on the client computer in response to the print instruction. At block 1204, a selectable language localization image is displayed within the print dialogue user interface. At block 1206, names of selectable localized languages are displayed in response to a selection of the language localization image of block 1204. At block 1208, a localized language is set on a printing device in response to the selection of a localized language name.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
displaying a selectable language localization image on a menu page of a printing device;
in response to a selected language localization image, displaying selectable world regions;
in response to a selected world region, displaying selectable sub-regions; and
in response to a selected sub-region, setting a localized language for the printing device.

2. A processor-readable medium as recited in claim 1, wherein displaying selectable world regions comprises displaying selectable world continents.

3. A processor-readable medium as recited in claim 1, wherein displaying selectable sub-regions comprises displaying a flag that uniquely identifies each sub-region.

4. A processor-readable medium as recited in claim 1, wherein the menu page is presented on a touch sensitive control screen of the printing device.

5. A processor-readable medium as recited in claim 1, wherein the menu page is presented on a key-based control panel of the printing device.

6. A processor-readable medium as recited in claim 1, wherein the menu page is presented on the screen of a networked computer by an embedded web server of the printing device.

7. A processor-readable medium comprising processor-executable instructions configured for:
displaying a selectable language localization image on a menu page of a printing device;
in response to a selected language localization image, displaying names of selectable localized languages, each name having text characters corresponding to a selectable localized language identified by the name; and
in response to a selected localized language, setting the printing device to function in a localized language representing the selected localized language.

8. A processor-readable medium as recited in claim 7, wherein the menu page is presented on a screen selected from a group of screens comprising:
a touch sensitive screen on a front panel of the printing device;
a key-based screen on a front panel of the printing device; and
a computer screen on a computer networked to the printing device.

9. A processor-readable medium comprising processor-executable instructions configured for:
receiving a print instruction initiated from within an application program;
displaying a print dialogue user interface; and
within the print dialogue user interface, displaying a selectable language localization image.

10. A processor-readable medium as recited in claim 9, comprising further processor-executable instructions configured for:
in response to a selection of the language localization image, displaying selectable localized language names, each localized language name having text characters that correspond to a localized language identified by the localized language name; and
in response to a selected localized language name, sending a language instruction to a printing device, the language instruction configured to set the printing device to function in a localized language corresponding to the selected localized language name.

11. A method of setting a localized language function on a printing device comprising:
displaying a selectable language localization image on a menu page of a printing device;
if the language localization image is selected, displaying selectable world regions;
if a world region is selected, displaying selectable sub-regions; and
if a sub-region is selected, setting a localized language for the printing device that corresponds to the sub-region.

12. A method of setting a localized language function on a printing device comprising:
displaying a selectable language localization image on a menu page of a printing device;
if the language localization image is selected, displaying selectable localized language names, each localized language name displayed with text characters that correspond to a localized language identified by the localized language name; and
if a localized language name is selected, setting the printing device to function in a localized language corresponding to the localized language name.

13. A method of setting a localized language function on a printing device comprising:
receiving a print instruction initiated from within an application program;
displaying a print dialogue user interface; and
within the print dialogue user interface, displaying a selectable language localization image.

14. A method as recited in claim 13, further comprising:
if the language localization image is selected, displaying selectable localized language names, each localized language name having text characters that correspond to a localized language identified by the localized language name; and
if a localized language name is selected, sending a language instruction to a printing device, the language instruction configured to set the printing device to function in a localized language corresponding to the selected localized language name.

15. A printer comprising:
a memory;
a front panel display screen; and
a plurality of menu pages stored in the memory and displayable on the front panel display screen, each of the plurality of menu pages including at least one graphical image that is selectable to establish a localized language setting for the printer.

16. A printer as recited in claim 15, wherein the plurality of menu pages further comprises an initial menu page having a language localization graphical image that is selectable to establish a localized language setting for the printer.

17. A printer as recited in claim 16, wherein the plurality of menu pages further comprises a second menu page having graphical images of selectable world regions, the second menu page displayable on the front panel display screen upon a selection of the language localization graphical image from the initial menu page.

18. A printer as recited in claim 17, wherein the plurality of menu pages further comprises a third menu page having graphical images of selectable sub-regions, the third menu page displayable on the front panel display screen upon a selection of a world region from the second menu page.

19. A printer as recited in claim 15, wherein the front panel display screen is a touch sensitive display screen capable of receiving selected input from a user touching the touch sensitive display screen.

20. A printer as recited in claim 15, wherein the front panel display screen is a key-based display screen capable of receiving selected input from a user pressing buttons on either side of the key-based display screen.

21. A printer comprising:
a memory;
a front panel display screen; and
an initial menu page stored in the memory and displayable on the front panel display screen, the initial menu page having a language localization graphical image that is selectable to establish a localized language setting for the printer.

22. A printer as recited in claim 21, further comprising a second menu page having localized language names selectable to establish a localized language setting for the printer, each localized language name having text characters that correspond to a localized language identified by the localized language name, the second menu page stored in memory and displayable on the front panel display screen if the language localization graphical image is selected from the initial menu page.

23. A printer comprising:
an embedded web server; and
a plurality of web page menus associated with the embedded web server and configured to be served up to a client computer by the embedded web server, each of the plurality of web pages including at least one graphical image that is selectable to establish a localized language setting for the printer.

24. A printer comprising:
an embedded web server;
an initial web page menu having a selectable language localization graphical image, the embedded web server configured to serve the web page menu to a client computer; and
a second web page menu having localized language names selectable to establish a localized language setting for the printer, each localized language name having text characters that correspond to a localized language identified by the localized language name, the embedded web server configured to serve the second web page menu to the client computer if the language localization graphical image is selected from the initial web page menu.

25. A computer comprising:
an application program configured to generate print data;
a printer driver configured to accept print data from the application program and format the print data for a printer; and
a graphical image associated with the printer driver, the graphical image displayable as part of a print dialogue user interface generated by the printer driver and selectable to establish a localized language setting for the printer.

26. A computer as recited in claim 25, further comprising a plurality of localized language names displayable within the print dialogue user interface in response to a selection of the graphical image, each of the localized language names comprising text characters that correspond to a localized language identified by the localized language name, and each of the localized language names selectable to establish a localized language setting for the printer that corresponds to a localized language identified by the localized language name.
